(19) United States
(12) Patent Application Publication
(10) Pub. No.: US 2026/0364838 A1
(43) Pub. Date: Nov. 19, 2026

(54) SHAVING RAZORS AND CARTRIDGES

(71) Applicant: The Gillette Company LLC, Boston, MA (US)

(72) Inventors: Robert Harold Johnson, Hingham, MA (US); Maggie Rae Gehling, Boston, MA (US); Thomas William Sherman, Bloomington, IN (US)

(21) Appl. No.: 19/673,083

(22) Filed: May 11, 2026

Related U.S. Application Data
(60) Provisional application No. 63/807,106, filed on May 16, 2025.

(51) Int. Cl. B26B 21/40; B26B 21/22

(52) U.S. Cl. CPC B26B 21/4018; B26B 21/222; B26B 21/4031

(57) ABSTRACT

A shaving razor with a housing having at least one blade with a blade edge. A first guard bar is in front of the blade. The first guard bar has a plurality of projections defining a plurality of open slots. A second guard is spaced apart from the first guard and has a row of a plurality of projections defining a plurality of open slots extending generally transverse to the blade edge. An intermediate guard is positioned between the first guard and the second guard. The intermediate guard is spaced apart from the second guard to define a gap of about 0.20 mm to about 0.35 mm. The intermediate guard has a row of a plurality of circular projections defining a plurality of open slots extending transverse to the blade edge generally aligned with the open slots of the second guard and the open slots of the first guard bar.

### FIELD

The present invention relates to shaving razors and more particularly to shaving razor cartridges having a housing with a guard enabling for the orientation and passage of hair to a blade for efficient and effective shaving.

### BACKGROUND

In recent years shaving razors with numerous blades have been proposed in the literature and commercialized, e.g., in United States 2005/0039337 A1 published on Feb. 24, 2005, which generally describes a type of design that has been commercialized as the five bladed Fusion™ razor by The Gillette Company.

Many shaving consumers prefer the look and feel of a close smooth shave and thus shave on a daily basis; however, there is a population of consumers that prefer not to shave on a daily basis. These consumers may prefer the look and feel of hair growth of one or more days. These consumers are often referred to as “skippers” because they will skip shaving for one or more days. The shaving habits of skippers produce a problem for typical shaving razors because these razors are designed to shave effectively on a daily basis and are not specifically designed for the shaving habits of skippers.

Short hairs are typical of hair growth of approximately twenty-four hours after shaving.-shave. Standard shaving razors cut shorter hairs rather effectively because the short hairs have a tendency to stand straight up, perpendicular to the skin surface. The edge of a blade on the razor is able to cut the short hair at an optimum angle. Longer hairs typically bend over as they grow and lay flat on the skin. The blade edge of a typical shaving razor will have the tendency to skive or cut the hair at a more parallel angle to the skin surface. Some hairs may lie flat such that the blade edge of the razor is unable to cut them. The user often must shave the same area repeatedly to cut hairs that were either uncut or not cut close enough to the skin surface, resulting in increased skin irritation.

It is therefore desirable to provide a shaving razor with the increased safety and comfort of a guard that provides superior long hair cutting performance while minimizing skin irritation.

### SUMMARY

In one aspect, the invention features, in general, a shaving razor with a housing having at least one blade with a blade edge. A first guard bar is in front of the blade. The first guard bar has a plurality of projections defining a plurality of open slots. A second guard is spaced apart from the first guard and has a row of a plurality of projections defining a plurality of open slots extending generally transverse to the blade edge. An intermediate guard is positioned between the first guard and the second guard. The intermediate guard is spaced apart from the second guard to define a gap of about 0.20mm to about 0.35mm. The intermediate guard has a row of a plurality of circular projections defining a plurality of open slots extending transverse to the blade edge generally aligned with the open slots of the second guard and the open slots of the first guard bar.

Particular embodiments may also optionally include the first guard bar defines a plurality of open slots extending perpendicular to the blade and aligned with the open slots defined by the circular projections.

In another aspect, the invention features, in general, a shaving razor cartridge with a housing having at least one blade with a blade edge. A second guard has a row of a plurality of projections defining a plurality of open slots that extend generally transverse to the blade edge. An intermediate guard is spaced apart from the second guard to define a gap of about 0.20mm to about 0.35mm. The intermediate guard has row of a plurality of circular projections defining a plurality of open slots extending transverse to the blade edge and generally aligned with the open slots of the second guard.

In another aspect, the invention features, in general, a shaving razor with a housing having at least one blade with a blade edge. A first guard bar is in front of the blade, the first guard bar defining a plurality of open slots. A second guard is in front of the first guard bar. The second guard spaced is apart from the first guard and has a row of a plurality of projections defining a plurality of open slots extending generally transverse to the blade edge. An intermediate guard is positioned between the first guard and the second guard. The intermediate guard has row of a plurality of circular projections defining a plurality of open slots extending transverse to the blade edge and aligned with the open slots of the second guard and the open slots of the first guard bar. The open slots of the intermediate guard bar have a width that is greater than the open slots of the first guard bar and a width of the open slots of the second guard.

In addition, any of the embodiments may optionally include a gap between the second guard and the intermediate guard of about 0.20mm to 0.35mm and/or a gap between the first guard bar and the intermediate guard of about 0.50mm and 1.0mm.

### BRIEF DESCRIPTION OF THE DRAWINGS

FIG. 1 is a front view of one possible embodiment of a shaving razor.

FIG. 2 is a front view of one possible embodiment of a cartridge, which may be incorporated into the shaving razor shown in FIG. 1.

FIG. 3 is a cross-sectional view of the cartridge, taken generally along the line 3-3 of FIG. 2.

FIG. 4 is an enlarged top view of a housing of the cartridge of FIG. 2.

FIG. 5 is an enlarged cross-sectional view of the housing of FIG. 3.

FIG. 6 is a schematic representation of a hair feeding angle.

FIG. 7 is a schematic representation of a hair incline angle.

FIG. 8 is a plot of hair feeding angles for two different cartridge designs.

FIG. 9 is a bar graph of percentage of combed hair for two different cartridge designs.

FIG. 10 is a plot of hair incline angles for two different cartridge designs.

FIG. 11 is a bar graph of percentage of lifted hair for two different cartridge designs.

FIG. 12 is a bar graph of percentage of average hair length 24 hours after shaving for two different cartridge designs.

### DETAILED DESCRIPTION

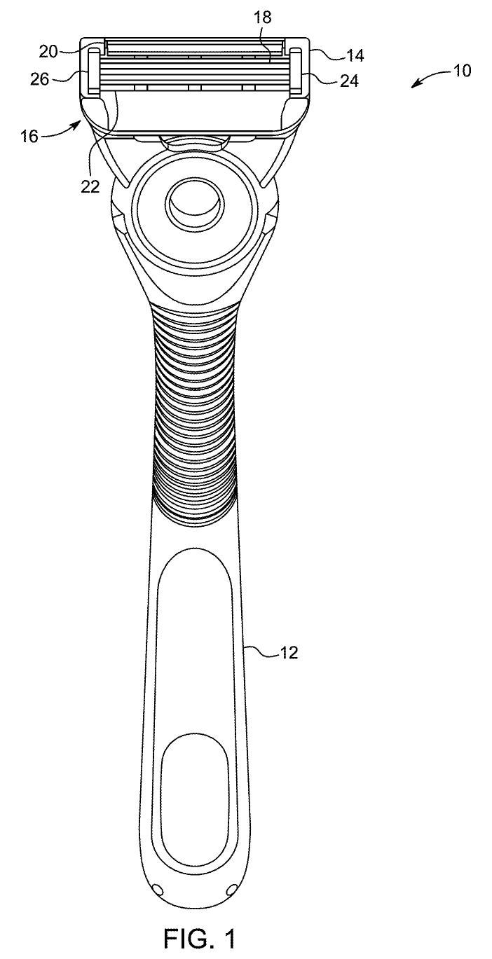

Referring to FIG. 1, one possible embodiment of the present disclosure is shown illustrating a shaving razor 10 having a handle 12 and a cartridge 14 (i.e., shaving razor cartridge). The shaving razor cartridge 14 may be mounted detachably on the handle 12 to enable the shaving razor cartridge 14 to be replaced by a fresh shaving razor cartridge 14 when shaving performance has diminished to an unsatisfactory level, or the shaving razor cartridge 14 may be attached permanently to the handle 12 with the intention that the entire shaving razor 10 be discarded when shaving performance becomes unsatisfactory to the user (i.e., disposable razor). The connection of the shaving razor cartridge 14 to a handle 12 may provide pivotal mounting of the shaving razor cartridge 14 with respect to the handle 12 so that the shaving razor cartridge 14 adjusts to follow the contours of the surface being shaved. In certain embodiments, features of the handle 12 may form part of the cartridge 14 when assembled together.

The shaving cartridge 14 may include a housing 16 having at least one blade 18, a cap 20 and a first guard bar 22. In certain embodiments, the cap 20 may comprise a water leachable shaving aid such as a polymeric matrix comprising a water-soluble polymer and a water-insoluble polymer comprising ethylene vinyl acetate (EVA). Other typical lubricious water-soluble polymers may include polyethylene oxide, polyvinyl pyrrolidone, polyacrylamide, modified hydroxyalkyl cellulose, polyvinyl imidazoline, polyvinyl alcohol, polysulfone, and polyhydroxyethylmethacrylate. In certain embodiments, the blades 18 may be mounted within the housing 16 and secured with at least one clip 24 and 26. Other assembly methods known to those skilled in the art may also be used to secure and/or mount the blades 18 to the housing 16 including, but not limited to, wire wrapping, cold forming, hot staking, insert molding, and adhesives. The first guard bar 22 may be positioned in front of the blades 18. The first guard bar 22 may be joined to or integral with the housing 16. For example, the first guard bar 22 may be injection molded as part of the housing 16.

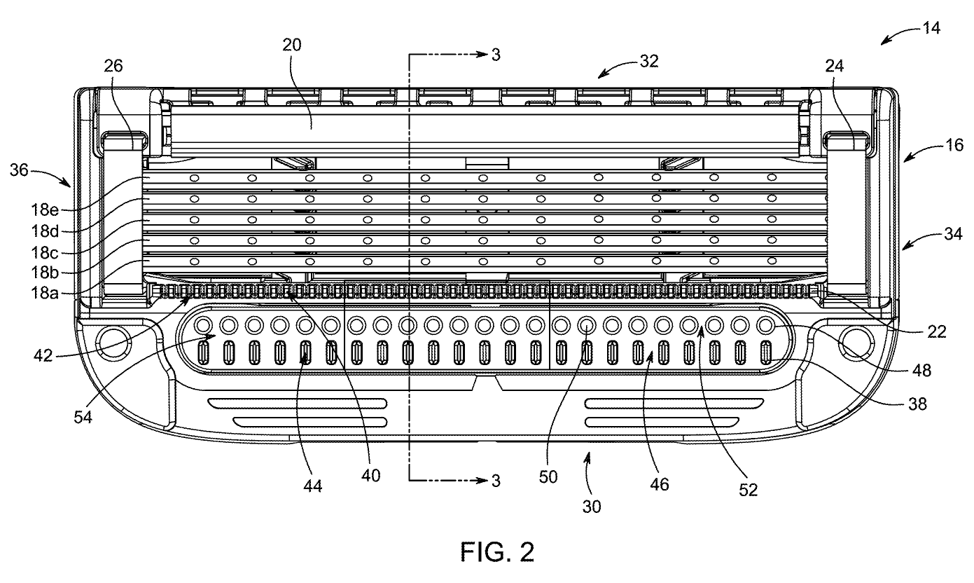

Referring to FIG. 2, a top view is shown illustrating the cartridge 14. The cartridge 14 may include one or more of the blades 18 mounted to the housing 16. The housing 16 may have a proximal end portion 30, a distal end portion 32, a first lateral end portion 34, and a second lateral end portion 36. The cap 20 may be mounted to the distal end portion 32 of the housing 16 and may extend from the first lateral end portion 34 to the second lateral end portion 36. The cap 20 may be part of the housing 16 or a separate component that is secured to the housing 16. The at least one blade 18 may extend from the first lateral end portion 34 to the second lateral end portion 36 of the housing 16. In the embodiment shown, the housing 16 has a first blade 18a, a second blade 18b, a third blade 18c, a fourth blade 18d and a fifth blade 18e. Although five blades are shown it is understood that more or less blades 18 may be mounted within the housing 16. The blades 18 are shown secured within the housing 16 with the clips 24 and 26, but other assembly methods known to those skilled in the art may also be used.

The first guard bar 22 may extend longitudinally (e.g., parallel to the blades 18) from the first lateral end portion 34 to the second lateral end portion 36 and may be located between the first blade 18a and a second guard 38. The first guard 22 may be located directly adjacent the first blade 18a. One or both of the first guard bar 22 and the second guard 38 may be integral with the housing 16 or may be mounted and/or secured to the housing using mechanical, thermal or chemical means. The second guard 38 may also extend longitudinally between the first lateral end portion 34 to the second lateral end portion 36. The first guard bar 22 may include a plurality of spaced apart projections 40 that define a plurality of slots 42 extending perpendicular to the blade 18. The projections 40 may extend along the entire length of the first guard bar 22, or they may extend along only certain sections of the first guard bar 22, such as the middle or toward the end portions 34 and 36. As will be described in greater detail below, the projections 40 and the open slots 42 may be configured for the management of skin and may aid in guiding hair to the first blade 18a. The projections 40 and the open slots 42 may orient the hair in an upward direction away from the skin surface and present it to the first blade 18a to provide for efficient and accurate cutting of the hair. In certain embodiments, the first guard bar 22 and the projections 40 may be configured for guiding longer hairs to the blades 18. Long hairs may include hair that has not been shaved for longer than 48 hours, 72 hours or longer. The length of such hairs may be greater than about 0.01mm. Longer hairs typically laying flat against the surface of the skin and are thus more difficult to lift and present to the blades 18, thus resulting in a missed or skive cut.

The second guard 38 may be in front of and spaced apart from the first guard bar 22. The second guard may include a row of a plurality of projections 44 defining a plurality of open slots 46 extending generally transverse to the blades 18. In certain embodiments, the plurality of projections 44 of the second guard 38 may be generally oblong or oval shaped to help guide hair. An intermediate guard 48 may be positioned between the first guard bar 22 and the second guard 38. The intermediate guard 48 may include a row of a plurality of projections 50 defining a plurality of open slots 52 extending transverse to the blades 18 and aligned with the open slots 46 of the second guard 38 and the plurality of open slots 42 of the first guard bar 22. The projections 50 may be circular to facilitate the orientation and passage of hair. It is understood the open slots 46 and/or the open slots 52 may not necessarily be aligned with every one of the open slots 42 of the first guard bar 22. For example, the open slots 46 and/or the open slots 52 may be aligned with every other open slot 42 of the first guard bar 22. The projections 50 may be aligned with the projections 44 of the second guard 38. The intermediate guard 48 may be spaced apart from the second guard 38 to define a gap 54. For example, the row of projections 50 of the intermediate guard 48 may be spaced apart from the row of projections 44 of the second guard 38. It is understood that the intermediate guard 48, the second guard 38 and/or the first guard bar 22 may be integral with the cartridge 14 (e.g., housing 16). However, in other embodiments, the intermediate guard 48, the second guard 38 and/or the first guard bar 22 may be located on the handle 12 and removably mounted to the housing 16. Accordingly, various parts of the handle 12 may form part of the cartridge 14 when the cartridge 14 is connected to the handle 12.

The housing 16, the first guard bar 22, the second guard 38 and/or the intermediate guard 48 may be injection molded from a rigid polymeric material. Alternatively, the housing 16 the first guard bar 22, the second guard 38 and/or the intermediate guard 48 may be manufactured (e.g., machined, formed or casted) from a metal, such as stainless steel or aluminum. In certain embodiments the first guard bar 22, the second guard 38 and/or the intermediate guard 48 may be molded from the same material as the housing 16, for example, Acetal (polyoxymethylene) or Noryl™ (a blend of polyphenylene oxide (PPO) and polystyrene developed by General Electric Plastics, now SABIC Innovative Plastics). Other manufacturing methods known by those skilled in the art may also be used, such as 3D printing. A metal or rigid polymeric material may allow the housing 16, the first guard bar 22, the second guard 38 and/or the intermediate guard 48 to maintain a consistent geometry during shaving and enhance the ability of the first guard bar 22, the second guard 38 and/or the intermediate guard 48 to lift and orient hairs. For example, the first guard bar 22, the second guard 38 and/or the intermediate guard 48 may be of sufficient stiffness such that the plurality of projections 40, 44 and 50 do not bend or flex under normal shaving conditions, which may adversely influence shave geometry.

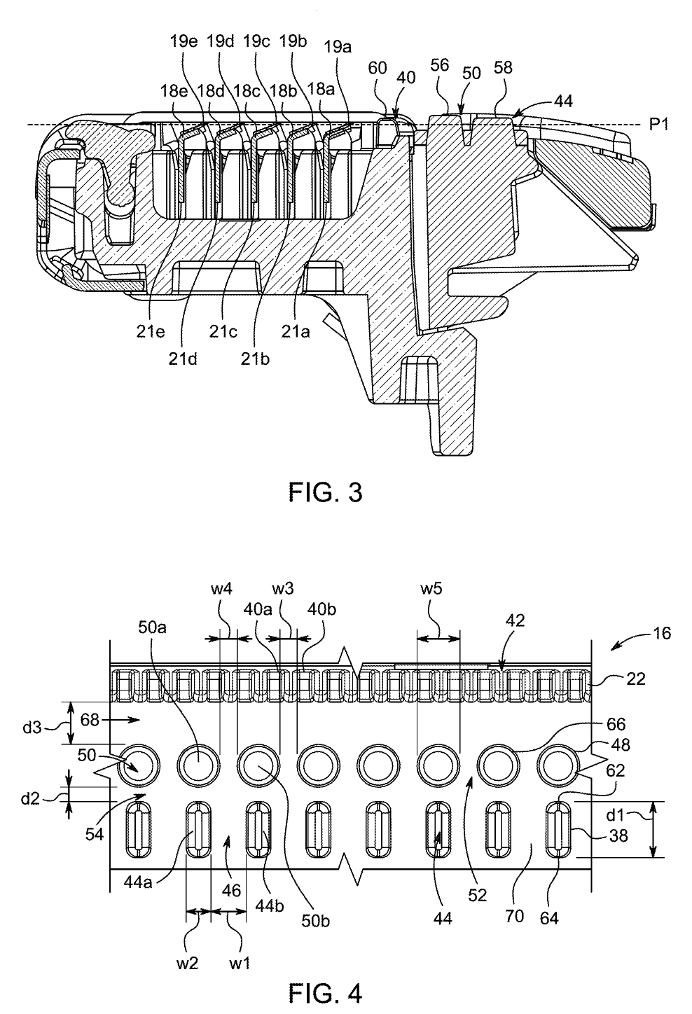

Referring to FIG. 3, a cross-sectional view of the razor cartridge 14 is shown. The blades 18a, 18b, 18c, 18d and 18e may each have a respective blade edge 19a, 19b, 19c, 19d and 19e configured to cut the hair. The blades 18a, 18b, 18c, 18d and 18e may be mounted on respective blade support members 21a, 21b, 21c, 21d and 21e. However, it is understood the blades 18a, 18b, 18c, 18d and 18e may be bent unitary blades. The plurality of blade edges 19a, 19b, 19c, 19d and 19e may define a shave plane P1. The first guard bar 22, the second guard 38 and the intermediate guard 48 may be positioned above the shave plane P1. In certain embodiments, a top surface 58 of the projections 44 of the second guard 38 (FIG. 2) and a top surface 56 of the projections 50 of the intermediate guard 48 may be positioned above a top surface 60 of the projections 40 of the first guard bar 22 (FIG. 2). The top surface 58 of the projections 44 of the second guard 38 (FIG. 2) and the top surface 56 of the projections 50 of the intermediate guard 48 may facilitate the lifting of longer hairs. In certain embodiments, the top surface 58 of the projections 44 of the second guard 38 (FIG. 2) and/or the top surface 56 of the projections 50 of the intermediate guard 48 may be positioned 0mm to 0.25mm and preferably about 0.05mm to 0.20mm above the shave plane P1.

Referring to FIG. 4, an enlarged top view of the housing 16 is shown. In certain embodiments, the plurality of projections 44 of the second guard 38 may be spaced apart to define the plurality of open slots 46. For example, adjacent projections 44a and 44b may be spaced apart to define a width “w1” of the slot 46. The width “w1” may be about 0.60mm to about 1.0mm and preferably about 0.70mm to about 0.90mm. The plurality of projections 44 of the second guard 38 may have a width “w2” of about 0.30mm to about 0.70mm and preferably about 0.40mm to about 0.60 mm. In certain embodiments, the plurality of projections 44 may extend in a direction toward the blades 18 (FIG. 2) from a rear face 62 to a front face 64 a distance “d1” of about 0.75mm to about 2.0mm and preferably about 1.0mm to about 1.50mm. The rear face 62 may face toward the projections 50 of the intermediate guard 48 and the front face 64 may face away from the projections 50 of the intermediate guard 48. The front face 64 may be convex to direct hairs laterally towards the open slots 46 between the adjacent projections 44 of the second guard 38. The rear face 62 may be convex to facilitate directing hairs between the adjacent projections 50 of the intermediate guard 48.

The plurality of projections 44 of the second guard 38 may be spaced apart from the projections 50 of the intermediate guard 48 to define a gap 54 that extends therebetween. In certain embodiments, the gap 54 define a distance “d2” of about 0.20mm to 0.35mm and more preferably about 0.25mm to 0.30mm. The width “w1” may be sufficiently sized to funnel hairs without trapping or catching hairs between the projections 44 of the second guard 38. The size of the gap 54 may facilitate hairs to relax or lift in a more upward orientation as the hairs are directed toward the projections 50 of the intermediate guard 48, as well as prevent trapping or pinching hairs between the projections 44 and the projections 50. The projections 50 may have a convex surface 66 to direct hairs laterally towards the open slots 52 between the adjacent projections 50 of the intermediate guard 48 and toward the first guard 22.

The plurality of projections 50 may define the plurality of open slots 52 that extend transverse to the blades 18 (FIG. 2). The open slots 52 may be generally aligned with the open slots 46 of the second guard 48 and the open slots 42 of the first guard bar 22 to allow hair to pass freely toward the blades 18 (FIG. 2). In certain embodiments, the open slots 42 and the open slots 52 may have the same width. For example, the open slots 42 of the first guard bar 22 may have a width “w3” between the adjacent projections 40a and 40b of about 0.20 mm to 0.35 mm and more preferably about 0.25 mm to 0.30 mm and the open slots 52 of the intermediate guard 48 may have a width “w4” between the adjacent projections 50a and 50b of about 0.20 mm to 0.35 mm and more preferably about 0.25 mm to 0.30 mm. In certain embodiments, the projections 50 of the intermediate guard may have a width “w5” of about 0.75 mm to about 1.25 and more preferably about 0.90 mm to about 1.10 mm. The projections 50 may be generally circular with an arcuate outer surface to help facilitate the directing of hairs through the open slots 52 and towards the open slots 42 of the first guard bar 22. The intermediate guard 48 may be spaced apart from the first guard bar 22 to provide a gap 68. For example, the projections 50 of the intermediate guard 48 may be spaced apart from the projections 40 of the first guard bar 22 by a distance “d3” of about 0.50 mm to about 1.0 mm and preferably about 0.65 mm to 0.85 mm.

The projections 40 of the first guard bar 22, the projections 50 of the intermediate guard 48 and/or the projections 44 of the second guard 38 may extend in an upward direction from a platform 70 of the housing 16. It is understood that the projections 40 of the first guard bar 22, the projections 50 of the intermediate guard 48 and/or the projections 44 of the second guard 38 may be tapered outwardly toward the platform 70 of the housing 16. For example, the width “w5” of the projections 50 may be smaller measured at the top surface 56 of the projections 50 than towards the platform 70. Similarly, the with “w2” of the projections 44 may be smaller toward the top surface 58 than toward the platform 70. The various dimensions for the projections 44 and 50 may be measured at the platform 70.

Hairs may be initially presented to the second guard 38 during a shaving stroke. The projections 44 (e.g., the front face 64) may facilitate lifting and moving the hairs to the open slots 46 of the second guard 38. The width “w1” may facilitate the funneling of hair toward the intermediate guard 38. The distance “d2” (the gap 54) between the second guard 38 and the intermediate guard 48 may facilitate releasing of trapped hairs and rinsing. For example, hairs that may have been trapped under the projections 44 may be released when they reach the gap 54. The projections 44 may drag along the skin to help lightly scrape the skin and lift the hairs.

The convex surfaces of the rear and front faces 62 and 64 of the projections 44 and 50, respectively, may help minimize trapped hairs, improve rinsing of shaving debris and funnel uncut hairs through the slots 52 of the intermediate guard 48. The distance “d3” (the gap 68) between the intermediate guard 48 and the first guard bar 22 may facilitate releasing of trapped hairs and rinsing. For example, hairs that may have been trapped under the projections 50 may be released when they reach the gap 68. The projections 50 may drag along the skin to help lightly scrape the skin and lift the hairs. The top surface 58 of the projections 44 and the top surface 56 of the projections 50 may be flat to facilitate the gentle scraping of skin to facilitate the release of hairs (FIG. 3). The width “w2” of the projections 44 and the width “w4” of the projections 50 may be sufficiently large enough not to cause discomfort and/or irritation by scratching the skin.

Hair may track through the slots 40 in the first guard 22 and be cut by the first blade 18a (FIG. 2), while the first guard bar 22 protects the skin. The width of a human hair is about 0.10mm. If the width of the open slots 46, 52 and 42 are less than about 0.10mm, then the hair may be caught up in the slots 42 and prevent other hairs from properly passing through the open slots 46, 52 and 42 and to the blade blades 18 (FIG. 2). If the width of the open slots 46, 52 and 42 are too small they may hamper proper rinsing resulting in a buildup of shaving debris (e.g., shaving aid, hair, dirt) between the open slots 46, 52 and 42, thus decreasing the effectiveness of the blades 18 to cut hair. This may become even more critical for users that shave infrequently. Longer hairs would be even more likely to become trapped and difficult to rinse out. The longer hairs would also be more likely to trap additional hairs, shaving aids, dirt and debris. If the slots 42, 52 and 46 are not properly rinsed, cut hair and other shaving debris may be pushed through, towards the blades 18 (FIG. 2), thus hampering the ability of the blades 18 to properly cut hair, which may result in nicks, cuts, uncut hairs and an inefficient shave that requires more passes of the blades 18 (FIG. 2) on the user’s skin.

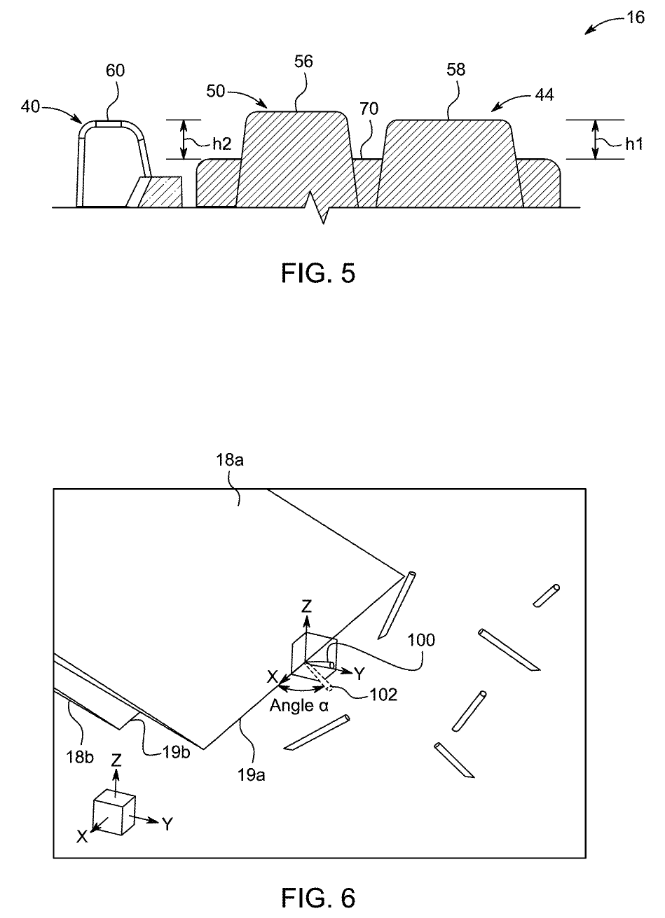

Referring to FIG. 5, an enlarged cross-sectional view of the housing of FIG. 3 is illustrated. The projections 44 and 50 may extend from the platform 70. The projections 44 may have a height “h1” that extends from the top surface 58 to the platform 70 about 0.20mm to about 0.50mm and preferably about 0.30mm to 0.40mm. The projections 50 may have a height “h2” that extends from the top surface 56 to the platform 70 about 0.30mm to about 0.60mm and preferably about 0.35mm to 0.45mm. In certain embodiments, the top surface 56 of the projection 50 may be above the top surface 60 of the projection 40 and the top surface 58 of the projection 44. It is believed, without being held to theory, that alternating the height of the projections 44, 50 and 40 (e.g., from low, to high, back to low) as the hair travels toward the blade 18 (FIG. 2) may facilitate the release of trapped hairs.

Referring back to FIG. 2, the design of the housing 16 and the first guard bar 22, the second guard 38 and the intermediate guard 48 helps minimize trapped hairs. Standard guards can trap longer hairs so that they are held down against the skin when the primary or first blade is designed to engage them. The design of the first guard bar 22, the second guard 38 and the intermediate guard 48 allows for hairs to pass through without being trapped. If hair becomes trapped within or under a guard, successive or trailing hairs will not be able to be pushed upright by the guard and thus not presented properly to the blades 18. An upright hair has a greater likelihood of being cut closer by the blades 18. The first guard bar 22, the second guard 38 and the intermediate guard 48 also do not pinch the hair but allows the hair to pass through to be cut. The pinching of hair by guards often causes discomfort to the user. The top faces of the first guard bar 22, the second guard 38 and the intermediate guard 48 manage skin flow and maintain the cartridge 16 geometry during shaving.

Skin can push up into the open slots 46, 52 and 42 if they are too wide. Wider slots and flexible guards are less likely to maintain a consistent blade/guard geometry, which may result in nicks and cuts. It is more important to support the skin closer to the blades 18 (FIG. 2). Accordingly, the open slots 46 further away from the blades 18 can be larger to help funnel the hairs, while the open slots 42 and 52 closer to the blades may be smaller to align the hairs and support the skin to maintain a consistent blade/guard geometry.

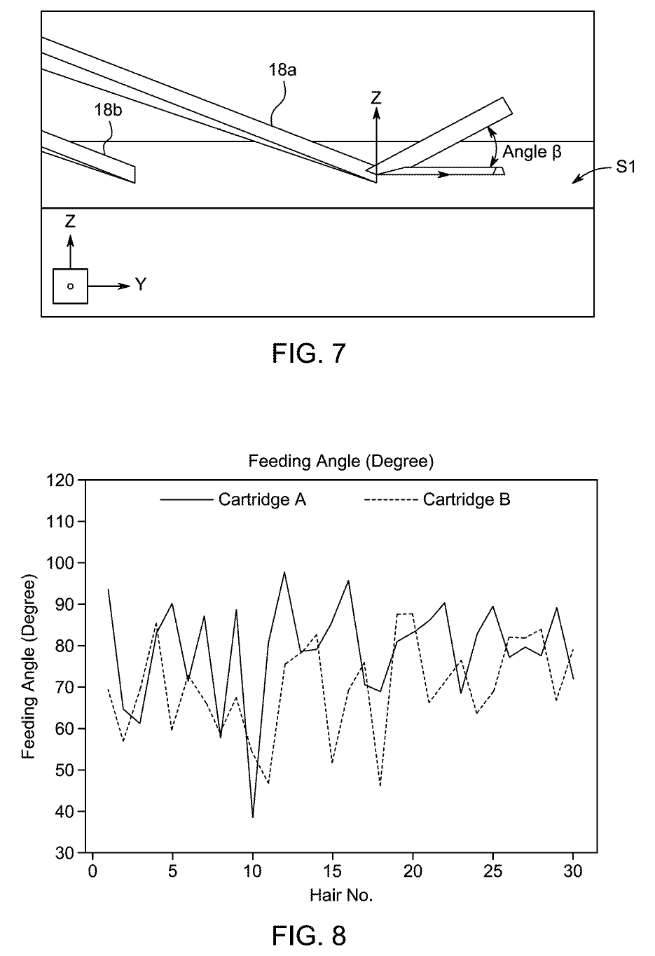

If hair remains flat and does not stand up, then the blade 18 (FIG. 2) may not effectively cut the hair close to the surface of the skin. The spacing and size of the projections 40, 44 and 50 of the first guard bar 22, the second guard 38 and the intermediate guard 48 may facilitate the release of any flat hairs back to a more upright orientation as the hair passes towards the blades 18 (FIG. 2). Feeding angle and incline angle are terms used to describe the angles at which a hair 100 is presented to the blade during shaving. For example, the feeding angle may be defined as the angle formed between the blade edge 19a and a projection of a hair 102 onto a plane P2 created by the cutting edges 19a and 19b of the blades 18a and 18b, in a direction orthogonal to the plane P2 (e.g., the shadow of the hair) (FIG. 6). The incline angle may be defined as the angle the hair H1 protrudes from the aforementioned plane P2 created by the cutting edges 19a and 19b of the blades 18a and 18b, as they glide across the surface of the skin S1. (FIG. 7). This angle is relative to the plane of the skin. Angle between the height of the hair and skin.

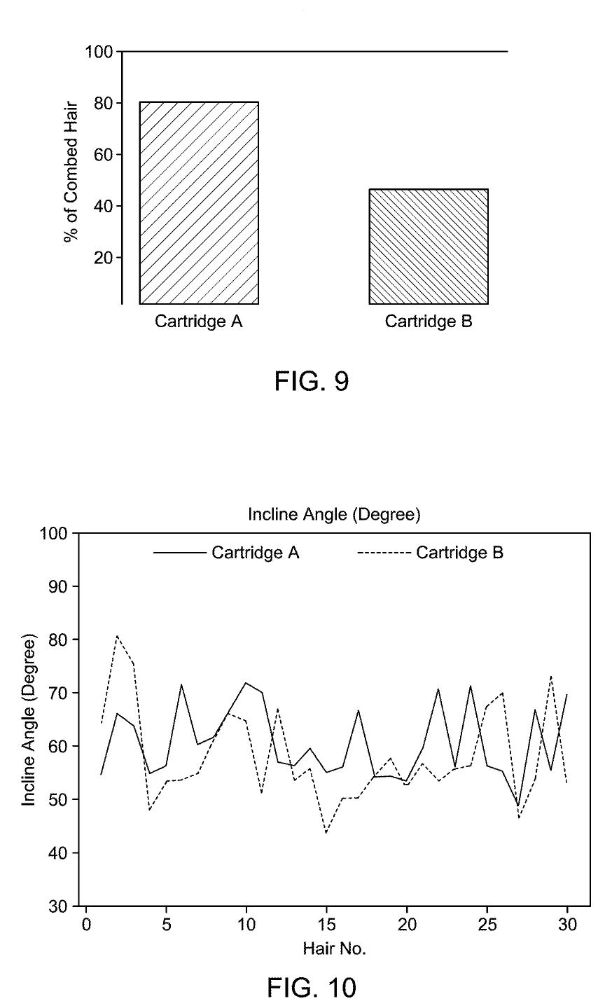

It is believed that a hair feeding angle that is closer to 90 degrees results in better blade contact with the hair, more efficient cutting and less missed hairs. Modeling and simulation data has shown that the design described in this patent provides a more optimum feeding angle of hair, i.e., a higher percentage of hairs falling between 70 degrees and 110 degrees, compared to one of the newest and most premium available cartridge designs (Gillette Labs). As shown in FIG. 8, Cartridge A (design described above) showed significantly more hairs with a feeding angle between 70 degrees and 110 degrees compared to Cartridge B (GilletteLabs) with a p value smaller than 0.05. The higher number of hairs within the desired feeding angle range resulted in a larger percentage of combed hairs, as shown in FIG. 9.

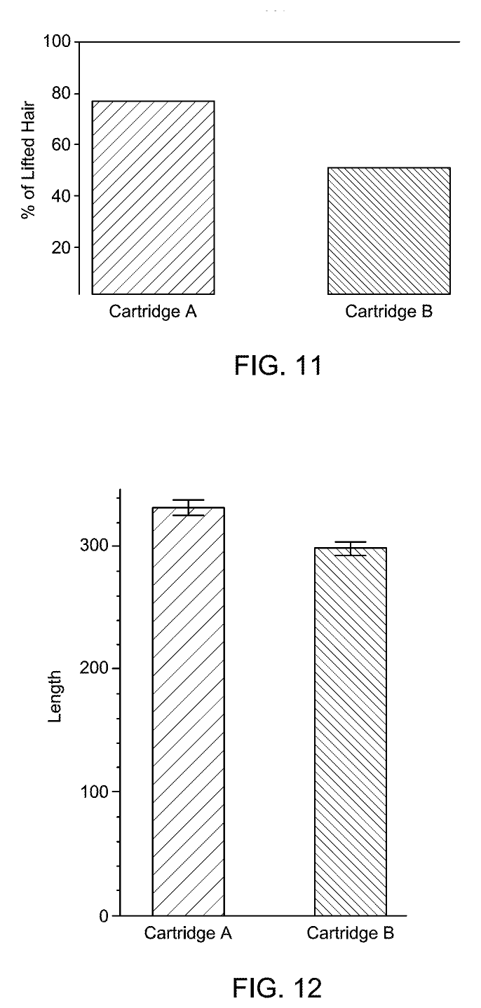

In addition, a higher incline angle results in lower incidence of skive cutting of hair and a closer shave. An optimal range for the incline angle is greater than 55 degrees (with 90 degrees being a hair standing straight up and 0 degrees a hair lying flat on the skin) Modeling and simulation data has shown that the above described design provides for a more optimum incline angle of hair. As shown in FIG. 10, cartridge A (design described above) showed significantly more hairs with an incline angle between 55 degrees and 90 degrees. The higher number of hairs within the desired incline angle range resulted in a larger percentage of lifted hairs, as shown in FIG. 11.

Analysis of single stroke efficiency testing (i.e., measurement of the average length of hairs on the cheek area of the face taken after a single shaving stroke when the hairs shaved were allowed to grow for twenty four hours previously) showed the cartridge design described above yielded significantly shorter hair lengths compared to rows of projections that had straight skin contacting surfaces (see FIG. 12). For example, a triangle or square shape instead of the circular geometry of the projections 50 or a rectangular shape instead of the oblong shape of the projects 44. The difference in hair lengths was shown to be 30 µm, which is a consumer meaningful difference. It is believed, without being held to theory, a circular geometry of the projections 50 and the oblong shape of the projections 44 may allow for more contact points with a hair compared to a straight line (e.g., triangle or square shape having a straight side), which may facilitate gradual alignment of the hairs and giving hairs several contact points. A straight line may provide for a more abrupt contact and redirection of the orientation of hair, which may depend more on the location of the root of the hair relative to the contact point of the projection. The gradual hair alignment provided by curved contact surfaces with the hair may facilitate contact with any point along the length of a hair shaft, enhancing effectiveness across diverse growth patterns. In contrast, a straight surface (e.g., triangle) may lead to abrupt alignment toward the blade when in ideal contact with hair root.

### REPRESENTATIVE EXAMPLES

A. A shaving razor cartridge comprising:
   a housing having at least one blade with a blade edge;
   a second guard having a row of a plurality of projections defining a plurality of open slots extending generally transverse to the blade edge;
   an intermediate guard positioned between the at least one blade and the second guard, the intermediate guard is spaced apart from the second guard to define a gap of about 0.20mm to about 0.35mm, wherein the intermediate guard has row of a plurality of projections defining a plurality of open slots extending transverse to the blade edge and generally aligned with the open slots of the second guard.
B. The shaving razor cartridge of paragraph A wherein the plurality of projections of the intermediate guard are circular.
C. The shaving razor cartridge of paragraphs A or B wherein a width of each of the projections of the intermediate guard is greater than a width of each of the projections of the second guard.
D. The shaving razor cartridge according to any one of paragraphs A-C wherein projections of the second guard are oblong.
E. A shaving razor cartridge according to any one of paragraphs A-D further comprising a first guard bar in front of the blade, wherein the intermediate guard is positioned between the first guard and the second guard.
F. The shaving razor cartridge of paragraph E wherein the first guard bar defines a plurality of open slots extending perpendicular to the blade and aligned with the open slots defined by the projections of the intermediate guard.
G. The shaving razor cartridge according to paragraphs E or F wherein the plurality of slots of the first guard bar have a width of 0.20mm to 0.35mm for allowing the free passage of hair during shaving.
H. The shaving razor cartridge according to any one of paragraphs A-G wherein the gap between the intermediate guard and the second guard is about 0.25mm to 0.30mm.
I. The shaving razor cartridge according to any one of paragraphs A-H wherein the open slots defined by the projections of the intermediate guard have a width of about 0.20mm to about 0.35mm.
J. The shaving razor cartridge according to any one of paragraphs A-I wherein a width of the projections of the intermediate guard is about 0.75mm to 1.25mm.
K. The shaving razor cartridge according to any one of paragraphs E, F or G wherein the intermediate guard is spaced apart from the first guard bar by a distance of 0.50mm to 1.0mm.
L. The shaving razor cartridge according to any one of paragraphs A-K wherein the open slots of the second guard have a width of about 0.60mm to about 1.0mm.
M. The shaving razor cartridge according to any one of paragraphs A-L wherein the open slots of the intermediate guard have a width of 0.20mm to 0.35mm.
N. The shaving razor cartridge according to any one of paragraphs A-M wherein the open slots of the second guard have a width that is greater than a width of the open slots of the intermediate guard.
O. The shaving razor cartridge, according to any one of paragraphs A-N wherein the plurality of projections of the second guard have a rear face with a convex surface facing the projections of the intermediate guard.
P. The shaving razor cartridge, according to any one of paragraphs A-O wherein the plurality of projections of the second guard have a front face with a convex surface opposite the convex surface facing the projections.
Q. The shaving razor cartridge according to any one of paragraphs A-P wherein the plurality of projections of the second guard has a rear face and a front face and a distance from the rear face to the front face is about 0.75mm to about 2.0mm.

The dimensions and/or values disclosed herein are not to be understood as being strictly limited to the exact numerical dimensions and/or values recited. Instead, unless otherwise specified, each such dimension and/or value is intended to mean both the recited dimension and/or value and a functionally equivalent range surrounding that dimension and/or value. For example, a dimension disclosed as “40mm” is intended to mean “about 40mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to anything disclosed or claimed herein or that it alone, or in any combination with any other reference or references, teaches, suggests or discloses anything disclosed or claimed herein. Further, to the extent that any meaning or definition of a term in this document conflicts with any meaning or definition of the same term in a document incorporated by reference, the meaning or definition assigned to that term in this document shall govern.

While particular forms of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of the present disclosure.

What is claimed is:

1. A shaving razor comprising:
a housing having at least one blade with a blade edge;
a first guard bar in front of the blade, the first guard bar having a plurality of projections defining a plurality of open slots;
a second guard spaced apart from the first guard and has a row of a plurality of projections defining a plurality of open slots extending generally transverse to the blade edge;
an intermediate guard positioned between the first guard and the second guard, the intermediate guard is spaced apart from the second guard to define a gap of about 0.20 mm to about 0.35 mm, wherein the intermediate guard has row of a plurality of circular projections defining a plurality of open slots extending transverse to the blade edge and generally aligned with the open slots of the second guard and the open slots of the first guard bar.

2. The shaving razor of claim 1 wherein the first guard bar defines a plurality of open slots extending perpendicular to the blade and aligned with the open slots defined by the circular projections.

3. The shaving razor of claim 2 wherein the plurality of slots of the first guard bar have a width of 0.20 mm to 0.35 mm for allowing the free passage of hair during shaving.

4. The shaving razor of claim 1 wherein the first guard bar is spaced apart from the blade.

5. The shaving razor of claim 1 wherein the gap between the intermediate guard and the second guard is about 0.25mm to 0.30mm.

6. The shaving razor of claim 1 wherein the open slots defined by the plurality of circular projections have a width of about 0.20mm to about 0.3mm.

7. The shaving razor of claim 6 wherein a width of the plurality of circular projections is about 0.75mm to 1.25mm.

8. The shaving razor of claim 1 wherein the intermediate guard is spaced apart from the first guard bar by a distance of 0.50mm to 1.0mm.

9. The shaving razor of claim 1 wherein the open slots of the second guard have a width of about 0.60mm to about 1.0mm.

10. The shaving razor of claim 1 wherein the open slots of the intermediate guard have a width of 0.20mm to 0.35mm.

11. The shaving razor of claim 1 wherein the open slots of the second guard have a width that is greater than a width of the open slots of the intermediate guard.

12. The shaving razor of claim 1 wherein the plurality of circular projections have a flat top surface.

13. The shaving razor of claim 1 wherein the plurality of circular projections have a height of about 0.30mm to 0.60mm.

14. The shaving razor of claim 1 wherein the plurality of projections of the second guard have a height that is less than a height of the plurality of circular projections of the intermediate guard.

15. The shaving razor of claim 1 wherein the plurality of projections of the second guard have a rear face with a convex surface facing the circular projections of the intermediate guard.

16. The shaving razor of claim 1 wherein the plurality of projections of the second guard have a front face with a convex surface opposite the convex surface facing the circular projections.

17. A shaving razor comprising:
a housing having at least one blade with a blade edge;
a first guard bar in front of the blade, the first guard bar defining a plurality of open slots;
a second guard in front of the first guard bar, the second guard spaced apart from the first guard and having a row of a plurality of projections defining a plurality of open slots extending generally transverse to the blade edge;
an intermediate guard positioned between the first guard and the second guard, the intermediate guard has row of a plurality of circular projections defining a plurality of open slots extending transverse to the blade edge and aligned with the open slots of the second guard and the open slots of the first guard bar, wherein the open slots of the intermediate guard bar have a width that is greater than the open slots of the first guard bar and a width of the open slots of the second guard.

18. The shaving razor of claim 17 wherein a gap between the second guard and the intermediate guard is about 0.20mm to 0.35mm.

19. The shaving razor of claim 17 wherein a gap between the first guard bar and the intermediate guard is about 0.50mm and 1.0mm.

20. The shaving razor of claim 17 wherein projections of the intermediate guard are oblong.
